(19) United States
(12) Patent Application Publication
(10) Pub. No.: US 2025/0309248 A1
(43) Pub. Date: Oct. 2, 2025

(54) ACTIVE MATERIAL, NEGATIVE ELECTRODE LAYER, BATTERY, AND METHOD FOR PRODUCING THE SAME

(71) Applicant: TOYOTA JIDOSHA KABUSHIKI KAISHA, Toyota-shi, Aichi-ken (JP)

(72) Inventors: Mitsutoshi OTAKI, Susono-shi (JP); Jun YOSHIDA, Mishima-shi (JP); Masanori HARATA, Kariya-shi (JP); Tatsuya EGUCHI, Kariya-shi (JP); Yasuhiro YAMAGUCHI, Kariya-shi (JP); Kota URABE, Kariya-shi (JP)

(73) Assignee: TOYOTA JIDOSHA KABUSHIKI KAISHA, Toyota-shi, Aichi-ken (JP)

(21) Appl. No.: 18/863,925

(22) PCT Filed: Mar. 14, 2023
(86) PCT No.: PCT/IB2023/000092

§ 371 Date: Nov. 7, 2024

(30) Foreign Application Priority Data
May 11, 2022 (JP) 2022-077968

(51) Int. Cl. H01M 4/38; H01M 4/02; H01M 10/0525

(52) U.S. Cl. CPC H01M 4/386; H01M 10/0525; H01M 2004/021

(57) ABSTRACT

An active material includes silicon. The active material has voids inside primary particles, and a void volume X of voids having a pore diameter of 10 nm or less among the voids is 0.015 cc/g or more.

### BACKGROUND OF THE INVENTION

### 1. Field of the Invention

The present disclosure relates to an active material, a negative electrode layer, a battery, and methods for producing the active material, the negative electrode layer, and the battery.

### 2. Description of Related Art

Batteries have actively been developed in recent years. For example, batteries for use in battery electric vehicles (BEV) or hybrid electric vehicles (HEV) have been developed in automotive industry. Silicon (Si) is known as an active material for use in batteries.

For example, Japanese Unexamined Patent Application Publication No. 2017-059534 (JP 2017-059534 A) discloses an all-solid-state battery system containing alloyed negative electrode active material particles such as silicon particles. U.S. Patent Application Publication No. 2012/0021283 discloses that silicon clathrate can be used as a negative electrode active material in a lithium ion battery through computation. Japanese Unexamined Patent Application Publication Nos. 2021-158003 (JP 2021-158003 A) and 2021-158004 (JP 2021-158004 A) each disclose an active material having a crystal phase of Type II silicon clathrate and voids inside primary particles.

### SUMMARY OF THE INVENTION

The theoretical capacity of Si is large and therefore Si is effective in increasing the energy density of batteries. However, Si undergoes a large volume change during charging and discharging.

The present disclosure provides an active material with a small volume change due to charging and discharging.

An active material according to a first aspect of the present disclosure includes silicon. The active material has voids inside primary particles, and a void volume X of voids having a pore diameter of 10 nm or less among the voids is 0.015 cc/g or more.

In the active material according to the first aspect, the void volume X may be 0.09 cc/g or less.

In the active material according to the first aspect, a void volume Y of voids having a pore diameter of 50 nm or less among the voids may be 0.05 cc/g or more and 0.25 cc/g or less.

In the active material according to the first aspect, a ratio (X/Y) of the void volume X to the void volume Y may be 0.17 or more and 0.41 or less.

In the active material according to the first aspect, a void volume Z of voids having a pore diameter of 100 nm or less among the voids may be 0.05 cc/g or more and 0.40 cc/g or less.

In the active material according to the first aspect, a ratio (X/Z) of the void volume X to the void volume Z may be 0.10 or more and 0.34 or less.

The active material according to the first aspect may have a crystal phase of Type II silicon clathrate.

In the active material according to the first aspect, a peak A at 2θ=20.09°±0.50° and a peak B at 2θ=31.72°±0.50° may be observed as peaks of the crystal phase of the Type II silicon clathrate in X-ray diffraction measurement using CuKα rays. When an intensity of the peak A is I_{A}, an intensity of the peak B is I_{B}, and a maximum intensity at 2θ=22° to 23° is I_{M}, I_{A}/I_{M} may be 1.75 or more and 10 or less, and I_{B}/I_{M} may be 1.35 or more and 7 or less.

The active material according to the first aspect may have a crystal phase of diamond-type silicon.

the negative electrode layer according to a second aspect of the present disclosure includes an active material including silicon. The active material has voids inside primary particles, and a void volume P of voids having a pore diameter of 10 nm or less among the voids is 0.015 cc/g or more.

In the negative electrode layer according to the second aspect, the void volume P may be 0.031 cc/g or less.

In the negative electrode layer according to the second aspect, a void volume Q of voids having a pore diameter of 50 nm or less among the voids may be 0.035 cc/g or more and 0.11 cc/g or less.

In the negative electrode layer according to the second aspect, a ratio (P/Q) of the void volume P to the void volume Q may be 0.22 or more and 0.39 or less.

In the negative electrode layer according to the second aspect, a void volume R of voids having a pore diameter of 100 nm or less among the voids may be 0.053 cc/g or more and 0.16 cc/g or less.

In the negative electrode layer according to the second aspect, a ratio (P/R) of the void volume P to the void volume R may be 0.14 or more and 0.30 or less.

A battery according to a third aspect of the present disclosure includes the negative electrode layer according to the second aspect. The battery further includes a positive electrode layer and an electrolyte layer disposed between the positive electrode layer and the negative electrode layer.

In a fourth aspect of the present disclosure, a method for producing the active material according to the first aspect includes obtaining a Na—Si alloy by causing a sodium source and a silicon source to react with each other, and producing a silicon clathrate-type crystal phase by heating the Na—Si alloy to reduce an amount of sodium in the Na—Si alloy. The producing the silicon clathrate-type crystal phase uses a scavenger to scavenge the sodium in the Na—Si alloy.

A method for producing the negative electrode layer according to a fifth aspect of the present disclosure includes producing an active material by the method for producing the active material according to the fourth aspect. The method further includes forming the negative electrode layer by using the active material.

A method for producing a battery according to a sixth aspect of the present disclosure includes producing an active material by the method for producing the active material according to the fourth aspect. The method further includes forming the negative electrode layer by using the active material.

The present disclosure produces such an effect that the active material with a small volume change due to charging and discharging can be obtained.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1A is a schematic perspective view illustrating a crystal phase of Type II silicon clathrate;

FIG. 1B is a schematic perspective view illustrating a crystal phase of diamond-type silicon;

FIG. 2 is a schematic sectional view illustrating an example of a battery in the present disclosure; and

FIG. 3 is a flowchart illustrating an example of a method for producing an active material in the present disclosure.

### DETAILED DESCRIPTION OF EMBODIMENTS

Hereinafter, detailed description will be given of an active material, the negative electrode layer, a battery, and methods for producing the active material, the negative electrode layer, and the battery according to the present disclosure.

### A. Active Material

The active material in the present disclosure contains silicon (Si), has voids inside primary particles, and has a large void volume X of voids having a pore diameter of 10 nm or less.

According to the present disclosure, the void volume X is large, and therefore the active material has a small volume change due to charging and discharging. The inventors have found in their studies thus far that crushing of the voids due to pressing is suppressed by increasing a void volume Z of minute voids having a pore diameter of 100 nm or less. Further, the inventors have found that the crushing of the voids due to pressing is remarkably suppressed by increasing a void volume Y of minute voids having a pore diameter of 50 nm or less. As a result of further studies, the inventors have found that the minute voids having the pore diameter of 10 nm or less are, similarly to the minute voids having the pore diameter of 50 nm or less, able to remarkably suppress the crushing of the voids due to pressing and effective in suppressing the volume change due to charging and discharging. Specifically, the void volume X of the minute voids having the pore diameter of 10 nm or less is increased to increase the filling rate of deposited lithium (Li) in the voids, thereby effectively suppressing the volume change due to charging and discharging.

The shape of the active material in the present disclosure is generally particulate. The active material may be primary particles, or secondary particles that are an agglomerate of the primary particles. In either case, the primary particles generally have voids inside.

The active material in the present disclosure preferably has many minute voids having the pore diameter of 10 nm or less. Compared with voids having a pore diameter of more than 10 nm, the voids having the pore diameter of 10 nm or less can suppress an increase in confining pressure because deposited Li can be accommodated at a higher filling rate. The void volume (cumulative pore volume) X of the voids having the pore diameter of 10 nm or less is, for example, 0.015 cc/g or more, and may be 0.0167 cc/g or more, 0.020 cc/g or more, 0.023 cc/g or more, or more than 0.0337 cc/g. The void volume X is, for example, 0.09 cc/g or less. The void volume X can be determined by, for example, mercury porosimeter measurement, Brunauer Emmett Teller (BET) measurement, a gas adsorption method, a three-dimensional scanning electron microscope (3D-SEM), or a three-dimensional transmission electron microscope (3D-TEM). The same applies to the method for measuring the void volume other than the void volume X.

The active material in the present disclosure preferably has many minute voids having the pore diameter of 50 nm or less. Compared with voids having a pore diameter of more than 50 nm and 100 nm or less, the voids having the pore diameter of 50 nm or less can further suppress the crushing of the voids due to pressing. The void volume Y of the voids having the pore diameter of 50 nm or less is, for example, 0.05 cc/g or more, and may be more than 0.065 cc/g, 0.072 cc/g or more, 0.083 cc/g or more, or 0.10 cc/g or more. The void volume Y is, for example, 0.25 cc/g or less, and may be 0.22 cc/g or less.

The ratio of the void volume X to the void volume Y (X/Y) is preferably large. The ratio X/Y is, for example, 0.17 or more, and may be 0.19 or more, or 0.21 or more. The ratio X/Y is, for example, 0.41 or less.

The active material in the present disclosure preferably has many minute voids having the pore diameter of 100 nm or less. Compared with voids having a pore diameter of more than 100 nm, the voids having the pore diameter of 100 nm or less can suppress the crushing of the voids due to pressing. The void volume Z of the voids having the pore diameter of 100 nm or less is, for example, 0.05 cc/g or more, and may be 0.07 cc/g or more, 0.10 cc/g or more, or 0.12 cc/g or more. The void volume Z is, for example, 0.40 cc/g or less, and may be 0.39 cc/g or less, or 0.35 cc/g or less.

The ratio of the void volume X to the void volume Z (X/Z) is preferably large. The ratio X/Z is, for example, 0.10 or more, and may be 0.14 or more, or 0.16 or more. The ratio X/Z is, for example, 0.34 or less.

The active material in the present disclosure has the voids inside the primary particles. The voidage is, for example, 4% or more, and may be 10% or more. The voidage is, for example, 40% or less, and may be 20% or less. The voidage can be determined, for example, by the following procedure. First, an electrode layer containing the active material is sectioned by ion milling. Then, particles are photographed by observing the cross section with a scanning electron microscope (SEM). A silicon portion and a void portion are distinguished and binarized from the obtained photograph by using image analysis software. The areas of the silicon portion and the void portion are determined, and the voidage (%) is calculated from the following expression.

Voidage (%)=100×(area of void portion)/((area of silicon portion)+(area of void portion))

Specific image analysis and voidage calculation can be performed as follows. For example, Fiji ImageJ bundled with Java 1.8.0_172 (hereinafter referred to as “Fiji”) is used as the image analysis software. A secondary electron image and a backscattered electron image in the same field of view are synthesized to form an RGB color image. The obtained RGB image is then blurred by a function “Median (filter size=2)” in Fiji to remove pixel-by-pixel noise. Next, the silicon portion and the void portion in the SEM image are separately painted by using Fiji, and the void volume is calculated from the area ratio between the silicon portion and the void portion.

Regarding the RGB color imaging, both the secondary electron image and the backscattered electron image are represented in the gray scale. Therefore, a brightness x of each pixel in the secondary electron image is set to a red value, and a brightness y of each pixel in the backscattered electron image is set to a green value, for example. As a result, an RGB image is obtained with, for example, R=x, G=y, and B=(x+y)/2 in the individual pixels.

The average particle size (D₅₀) of the primary particles is, for example, 50 nm or more, and may be 100 nm or more, or 150 nm or more. The average particle size (D₅₀) of the primary particles is, for example, 3000 nm or less, and may be 1500 nm or less, or 1000 nm or less. The average particle size (D₅₀) of the secondary particles is, for example, 1 μm or more, and may be 2 μm or more, or 5 μm or more. The average particle size (D₅₀) of the secondary particles is, for example, 60 μm or less, and may be 40 μm or less. The average particle size (D₅₀) can be determined by observation with, for example, an SEM. The number of samples is preferably large. For example, the number of samples is 20 or more, and may be 50 or more, or 100 or more.

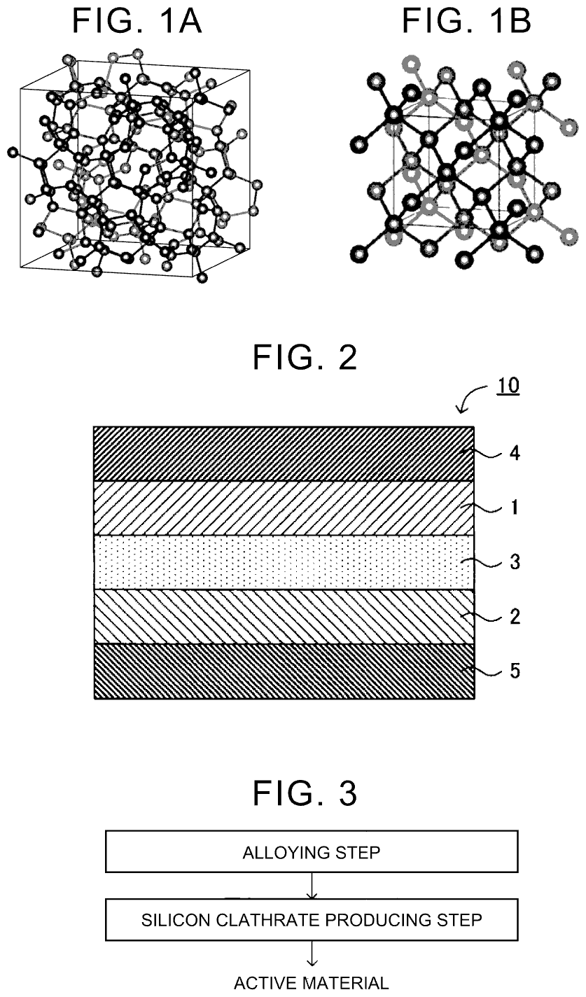

The active material in the present disclosure preferably has a silicon clathrate-type crystal phase. The silicon clathrate-type crystal phase may be a crystal phase of Type I silicon clathrate or a crystal phase of Type II silicon clathrate. For example, FIG. 1A shows Type II silicon clathrate. In such a silicon clathrate-type crystal phase, a plurality of Si elements forms polyhedrons (cages) including pentagons or hexagons. The polyhedrons have internal spaces that can contain metal ions such as Li ions. By inserting metal ions into the spaces, the volume change due to charging and discharging can be suppressed. Particularly in all-solid-state batteries, it is generally necessary to apply a high confining pressure in order to suppress the volume change due to charging and discharging. By using the active material in the present disclosure, it is possible to reduce the confining pressure to be applied to the all-solid-state battery. As a result, it is possible to suppress an increase in the size of a confining jig.

The active material in the present disclosure may or may not have the crystal phase of Type II silicon clathrate. When the active material has the crystal phase of Type II silicon clathrate, the active material may have the crystal phase of Type II silicon clathrate as a main phase. The “main phase” means that the peak belonging to the crystal phase has the highest diffraction intensity among the peaks observed by X-ray diffraction measurement. The phrase “not have the crystal phase” means that the peak of the crystal phase is not observed in the X-ray diffraction measurement.

The crystal phase of Type II silicon clathrate generally belongs to a space group (Fd-3m). The crystal phase of Type II silicon clathrate has typical peaks at positions of 2θ=20.09°, 21.00°, 26.51°, 31.72°, 36.26°, and 53.01° in X-ray diffraction measurement using CuKα rays. These peak positions may vary within a range of ±0.50°, ±0.30°, or ±0.10°.

In the crystal phase of Type II silicon clathrate, the peak at 2θ=20.090°±0.50° is a peak A, and the peak at 2θ=31.72°±0.50° is a peak B. The intensity of the peak A is represented by I_{A}, and the intensity of the peak B is represented by I_{B}. The maximum intensity at 2θ=22° to 23° is represented by I_{M}. The range of 2θ=22° to 23° is generally a range in which the peak of the crystal phase related to Si is not present. Therefore, it can be used as a reference.

The value of I_{A}/I_{M} is preferably more than 1. When the value of I_{A}/I_{M} is 1 or less, determination can be made that the crystal phase of Type II silicon clathrate is not substantially formed. The value of I_{A}/I_{M} is, for example, 1.75 or more, and may be 1.80 or more. The value of I_{A}/I_{M} is, for example, 10 or less, and may be 5 or less.

The value of I_{B}/I_{M} is preferably more than 1. When the value of I_{B}/I_{M} is 1 or less, determination can be made that the crystal phase of Type II silicon clathrate is not substantially formed. The value of I_{B}/I_{M} is, for example, 1.35 or more, and may be 1.40 or more. The value of I_{B}/I_{M} is, for example, 7 or less, and may be 4 or less.

The active material in the present disclosure may or may not have the crystal phase of Type I silicon clathrate. When the active material has the crystal phase of Type I silicon clathrate, the active material may have the crystal phase of Type I silicon clathrate as the main phase. The crystal phase of Type I silicon clathrate generally belongs to a space group (Pm-3n). The crystal phase of Type I silicon clathrate has typical peaks at positions of 2θ=19.44°, 21.32°, 30.33°, 31.60°, 32.82°, 36.29°, 52.39°, and 55.49° in the X-ray diffraction measurement using CuKα rays. These peak positions may vary within a range of ±0.50°, ±0.30°, or ±0.10°.

The active material in the present disclosure may or may not have a diamond-type Si crystal phase. As shown in FIG. 1B, in the diamond-type Si crystal phase, a plurality of Si elements forms tetrahedrons. The tetrahedrons do not have internal spaces that can contain metal ions such as Li ions, Therefore, the diamond-type Si crystal phase is less likely to suppress the volume change due to charging and discharging than the silicon clathrate-type crystal phase. The diamond-type Si crystal phase has higher structural stability than the silicon clathrate-type crystal phase.

The active material in the present disclosure may have the diamond-type Si crystal phase as the main phase. The diamond-type Si crystal phase has typical peaks at positions of 2θ=28.44°, 47.31°, 56.10°, 69.17°, and 76.37° in the X-ray diffraction measurement using CuKα rays. These peak positions may vary within a range of ±0.50°, ±0.30°, or ±0.10°.

When a peak C at 2θ=28.44°±0.50° is observed as the peak of the diamond-type Si crystal phase, the intensity of the peak C is represented by I_{C}. The value of I_{A}/I_{C} is, for example, more than 1, and may be 1.5 or more, 2 or more, or 3 or more. The preferable range of I_{B}/I_{C} is the same as the preferable range of I_{A}/I_{C}.

Although the composition of the active material in the present disclosure is not particularly limited, it is preferably represented by NaₓSi₁₃₆ (0≤x≤24). The value x may be 0 or more than 0. The value x may be 20 or less, 10 or less, or 5 or less. The active material in the present disclosure may contain an inevitable component (for example, Li). The composition of the active material can be determined by, for example, energy dispersive X-ray spectroscopy (EDX), X-ray diffraction (XRD), X-ray fluorescence spectroscopy (XRF), inductively coupled plasma (ICP), or atomic absorption spectroscopy. Compositions of other compounds can similarly be measured. An inevitable oxide film is generally formed on the surface of the active material. Therefore, the active material may contain a trace of oxygen (O). The active material may also contain a trace of carbon (C) derived from the production process.

The active material in the present disclosure is typically used in batteries. The active material in the present disclosure may be the negative electrode active material or a positive electrode active material, but is preferably the negative electrode active material. The present disclosure can also provide an electrode layer (negative electrode layer or positive electrode layer) including the active material described above, and a battery including the electrode layer. Examples of the method for producing the active material include a production method described later in “D. Method for Producing Active Material”.

### B. Negative Electrode Layer

The negative electrode layer in the present disclosure contains the active material described above.

According to the present disclosure, the negative electrode layer can have a small volume change due to charging and discharging by using the active material described above.

The negative electrode layer contains at least the negative electrode active material. The negative electrode active material is the same as that described above in “A. Active Material”. When the negative electrode layer is produced by pressing, the voids inside the primary particles of the negative electrode active material may be crushed. When the void volume Z of the voids having the pore diameter of 100 nm or less is large in the negative electrode active material before pressing, the crushing of the voids due to pressing is suppressed. When the void volume Y of the voids having the pore diameter of 50 nm or less is large, the crushing of the voids due to pressing is further suppressed. Since the voids having the pore diameter of 10 nm or less can accommodate deposited Li at a high filling rate, the increase in the confining pressure is suppressed when the void volume X is large.

The negative electrode active material contained in the negative electrode layer preferably has many minute voids having the pore diameter of 10 nm or less. A void volume P of the voids having the pore diameter of 10 nm or less is, for example, 0.015 cc/g or more, and may be 0.017 cc/g or more, or 0.019 cc/g or more. The void volume P is, for example, 0.031 cc/g or less.

The negative electrode active material contained in the negative electrode layer preferably has many minute voids having the pore diameter of 50 nm or less. A void volume Q of the voids having the pore diameter of 50 nm or less is, for example, 0.035 cc/g or more, and may be 0.04 cc/g or more, or 0.06 cc/g or more. The void volume Q is, for example, 0.11 cc/g or less, and may be 0.10 cc/g or less.

The ratio of the void volume P to the void volume Q (P/Q) is preferably large. The ratio P/Q is, for example, 0.22 or more, and may be 0.27 or more. The ratio P/Q is, for example, 0.39 or less.

The negative electrode active material contained in the negative electrode layer preferably has many minute voids having the pore diameter of 100 nm or less. A void volume R of the voids having the pore diameter of 100 nm or less is, for example, 0.053 cc/g or more, and may be 0.06 cc/g or more. The void volume R is, for example, 0.16 cc/g or less, and may be 0.14 cc/g or less.

The ratio of the void volume P to the void volume R (P/R) is preferably large. The ratio P/R is, for example, 0.14 or more, and may be 0.20 or more. The ratio P/R is, for example, 0.30 or less.

The ratio of the negative electrode active material in the negative electrode layer is, for example, 20 wt % or more, and may be 30 wt % or more, or 40 wt % or more. When the ratio of the negative electrode active material is too small, there is a possibility that a sufficient energy density cannot be obtained. The ratio of the negative electrode active material is, for example, 80 wt % or less, and may be 70 wt % or less, or 60 wt % or less. When the ratio of the negative electrode active material is too large, there is a possibility that the ionic conductivity and electronic conductivity of the negative electrode layer relatively decreases.

The negative electrode layer may contain at least one of an electrolyte, a conductive material, and a binder if necessary. Examples of the electrolyte include electrolytes described later in “C. Battery: 3. Electrolyte Layer”. Examples of the conductive material include a carbon material, metal particles, and a conductive polymer. Examples of the carbon material include particle carbon materials such as acetylene black (AB) and Ketjen black (KB), and fibrous carbon materials such as carbon fibers, carbon nanotubes (CNTs), and carbon nanofibers (CNFs). Examples of the binder include a rubber binder and a fluoride binder.

The thickness of the negative electrode layer is, for example, 0.1 μm or more and 1000 μm or less. The negative electrode layer in the present disclosure is typically used in batteries.

### C. Battery

FIG. 2 is a schematic sectional view illustrating an example of the battery in the present disclosure. A battery 10 shown in FIG. 2 includes a positive electrode layer 1, a negative electrode layer 2, an electrolyte layer 3 located between the positive electrode layer 1 and the negative electrode layer 2, a positive electrode current collector 4 that collects a current from the positive electrode layer 1, and a negative electrode current collector 5 that collects a current from the negative electrode layer 2. In the present disclosure, the negative electrode layer 2 is the negative electrode layer described above in “B. Negative Electrode Layer”.

According to the present disclosure, the battery can have a small volume change due to charging and discharging by using the negative electrode layer described above.

### 1. Negative Electrode Layer

Since the negative electrode layer in the present disclosure is the same as that described above in “B. Negative Electrode Layer”, description thereof will be omitted.

### 2. Positive Electrode Layer

The positive electrode layer contains at least a positive electrode active material. The positive electrode layer may contain at least one of an electrolyte, a conductive material, and a binder if necessary.

Examples of the positive electrode active material include an oxide active material. Examples of the oxide active material include layered rock-salt active materials such as LiCoO₂, LiMnO₂, LiNiO₂, LiVO₂, and LiNi_{1/3}Co_{1/3}Mn_{1/3}O₂, spinel active materials such as LiMn₂O₄, Li₄Ti₅O₁₂, and Li(Ni_{0.5}Mn_{1.5})O₄, and olivine active materials such as LiFePO₄, LiMnPO₄, LiNiPO₄, and LiCoPO₄.

A coating layer containing a Li-ion conductive oxide may be formed on the surface of the oxide active material. This is because the reaction between the oxide active material and a solid electrolyte (in particular, a sulfide solid electrolyte) can be suppressed. Examples of the Li-ion conductive oxide include LiNbO₃. The thickness of the coating layer is, for example, 1 nm or more and 30 nm or less. For example, Li₂S can also be used as the positive electrode active material.

The shape of the positive electrode active material is, for example, particulate. The average particle size (D₅₀) of the positive electrode active material is not particularly limited, but is, for example, 10 nm or more, and may be 100 nm or more. The average particle size (D₅₀) of the positive electrode active material is, for example, 50 μm or less, and may be 20 μm or less. The average particle size (D₅₀) can be calculated, for example, by measurement using a laser diffraction particle size distribution meter or a scanning electron microscope (SEM).

Since the electrolyte, the conductive material, and the binder used in the positive electrode layer are the same as those described above in “B. Negative Electrode Layer”, description thereof will be omitted. The thickness of the positive electrode layer is, for example, 0.1 μm or more and 1000 μm or less.

### 3. Electrolyte Layer

The electrolyte layer is formed between the positive electrode layer and the negative electrode layer, and contains at least an electrolyte. The electrolyte may be a solid electrolyte or a liquid electrolyte (electrolytic solution).

Examples of the solid electrolyte include inorganic solid electrolytes such as a sulfide solid electrolyte, an oxide solid electrolyte, a nitride solid electrolyte, and a halide solid electrolyte, and organic polymer electrolytes such as a polymer electrolyte. Examples of the sulfide solid electrolyte include solid electrolytes containing a Li element, an X element (X is at least one of phosphorus (P), arsenic (As), antimony (Sb), Si, germanium (Ge), tin (Sn), boron (B), aluminum (Al), gallium (Ga), and indium (In)), and a sulfur (S) element. The sulfide solid electrolyte may further contain at least one of an O element and a halogen element. Examples of the halogen element include a fluorine (F) element, a chlorine (Cl) element, a bromine (Br) element, and an iodine (I) element. The sulfide solid electrolyte may be glass (amorphous) or glass ceramic. Examples of the sulfide solid electrolyte include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂.

The electrolytic solution preferably contains a supporting salt and a solvent. Examples of the supporting salt (lithium salt) of the electrolytic solution having lithium ion conductivity include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃. Examples of the solvent used in the electrolytic solution include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). The electrolytic solution preferably contains two or more kinds of solvent.

The thickness of the electrolyte layer is, for example, 0.1 μm or more and 1000 μm or less.

### 4. Other Structures

The battery in the present disclosure preferably includes the positive electrode current collector that collects a current from the positive electrode layer, and the negative electrode current collector that collects a current from the negative electrode layer. Examples of the material for the positive electrode current collector include stainless steel (SUS), aluminum, nickel, iron, titanium, and carbon. Examples of the material for the negative electrode current collector include stainless steel (SUS), copper, nickel, and carbon.

The battery in the present disclosure may further include a confining jig that applies a confining pressure along a thickness direction to the positive electrode layer, the electrolyte layer, and the negative electrode layer. Particularly when the electrolyte layer is a solid electrolyte layer, the confining pressure is preferably applied in order to form a satisfactory ion conduction path and a satisfactory electron conduction path. The confining pressure is, for example, 0.1 MPa or more, and may be 1 MPa or more, or 5 MPa or more. The confining pressure is, for example, 100 MPa or less, and may be 50 MPa or less, or 20 MPa or less.

### 5. Battery

The type of the battery in the present disclosure is not particularly limited, but is typically a lithium ion battery. The battery in the present disclosure may be a liquid-state battery containing an electrolytic solution as the electrolyte layer, or an all-solid-state battery having a solid electrolyte layer as the electrolyte layer. The battery in the present disclosure may be a primary battery or a secondary battery, but is preferably the secondary battery. This is because it can repeatedly be charged and discharged, and is useful, for example, as a battery for vehicles.

The battery in the present disclosure may be a single cell or a stacked battery. The stacked battery may be a monopolar stacked battery (parallel-connected stacked battery) or a bipolar stacked battery (series-connected stacked battery). The shape of the battery is, for example, a coin shape, a laminate shape, a cylindrical shape, or a rectangular shape.

### D. Method for Producing Active Material

FIG. 3 is a flowchart illustrating an example of the method for producing the active material in the present disclosure. In the production method shown in FIG. 3, a Na—Si alloy is first obtained by causing a sodium (Na) source and a silicon (Si) source to react with each other (alloying step). Next, a silicon clathrate-type crystal phase is produced by heating the Na—Si alloy to reduce the amount of Na in the Na—Si alloy (silicon clathrate producing step). At this time, a scavenger is used to scavenge Na in the Na—Si alloy. As a result, an active material having a large void volume X and the silicon clathrate-type crystal phase can be obtained.

According to the present disclosure, the active material having a small volume change due to charging and discharging can be obtained by using the predetermined scavenger in the silicon clathrate producing step.

### 1. Alloying Step

The alloying step in the present disclosure is a step of obtaining the Na—Si alloy by causing the Na source and the Si source to react with each other.

The Si source is particles containing at least Si. The Si source may be Si alone or an alloy of Si and any other metal. When the Si source is an alloy, the alloy preferably contains Si as a main component. The ratio of Si in the alloy is, for example, 50 at % or more, and may be 70 at % or more, or 90 at % or more.

The Si source is preferably porous Si having many voids inside the primary particles. In the Si source, a void volume a of the voids having the pore diameter of 50 nm or less is, for example, 0.02 cc/g or more, and may be 0.05 cc/g or more, 0.10 cc/g or more, 0.11 cc/g or more, or 0.12 cc/g or more. The void volume a is, for example, 0.20 cc/g or less, and may be 0.19 cc/g or less. The BET specific surface area of the Si source is, for example, 20 m²/g or more, and may be 25 m²/g or more, or 30 m²/g or more. The BET specific surface area of the Si source is, for example, 200 m²/g or less. The average particle size (D₅₀) of the Si source is, for example, 0.5 μm or more and 10 μm or less.

Examples of the method for producing the Si source (porous Si) include a method of producing an alloy of magnesium (Mg) and Si (Mg—Si alloy) and then removing Mg from the Mg—Si alloy. The Mg—Si alloy is obtained, for example, by heating a mixture of Mg and Si. The ratio of Mg to Si (Mg/Si) is, for example, 1.0 or more, and may be 1.5 or more, or 2.0 or more. The ratio Mg/Si is, for example, 6.0 or less. Examples of the method for removing Mg from the Mg—Si alloy include a method of heating the Mg—Si alloy in an inert gas atmosphere containing oxygen to convert Mg in the Mg—Si alloy into a magnesium oxide (MgO) and then removing MgO with an acid solution. Examples of the acid solution include an aqueous solution containing hydrochloric acid (HCl) and hydrogen fluoride (HF).

Examples of the method for producing the Si source (porous Si) include a method of producing an alloy of Li and Si (Li—Si alloy) and then removing Li from the Li—Si alloy. The Li—Si alloy is obtained, for example, by mixing Li and Si. The ratio of Li to Si (Li/Si) is, for example, 1.0 or more, and may be 2.0 or more, 3.0 or more, or 4.0 or more. The ratio Li/Si is, for example, 8.0 or less. Examples of the method for removing Li from the Li—Si alloy include a method of causing the Li—Si alloy to react with a Li extraction agent. Examples of the Li extraction agent include alcohols such as methanol, ethanol, 1-propanol, 1-butanol, 1-pentanol, and 1-hexanol, and acids such as acetic acid, formic acid, propionic acid, and oxalic acid.

Examples of the method for producing the Si source (porous Si) include a method of producing an alloy of Mg and Si (Mg—Si alloy), then removing Mg from the Mg—Si alloy, then producing an alloy of Li and Si from which Mg has been removed (Li—Si alloy), and then removing Li from the Li—Si alloy.

The Na source contains at least Na. Examples of the Na source include metallic Na, sodium hydride (NaH), and metallic Na dispersions obtained by dispersing particles of metallic Na in oil.

Examples of the method for obtaining the Na—Si alloy by causing the Na source and the Si source to react with each other include a method of heating a mixture containing the Na source and the Si source. The heating temperature is, for example, 300° C. or more, and may be 310° C. or more, 320° C. or more, or 340° C. or more. The heating temperature is, for example, 800° C. or less, and may be 600° C. or less, or 450° C. or less. The alloying step is preferably performed under an inert atmosphere such as an argon (Ar) atmosphere.

The Na—Si alloy preferably has a Zintl phase. The Zintl phase has typical peaks at positions of 2θ=16.10°, 16.56°, 17.64°, 20.16°, 27.96°, 33.60°, 35.68°, 40.22°, and 41.14° in the X-ray diffraction measurement using CuKα rays. These peak positions may vary within a range of ±0.50° or ±0.30°. The Na—Si alloy preferably has the Zintl phase as a main phase. The Na—Si alloy may or may not have the crystal phase of Type I silicon clathrate.

Although the composition of the Na—Si alloy is not particularly limited, it is preferably represented by the composition of Na_{z}Si₁₃₆ (121≤z≤151). The value z may be 126 or more, or 131 or more. The value z may be 141 or less. Elements other than Na and Si may be present in the Na—Si alloy. Examples of the other elements include Li, potassium (K), rubidium (Rb), cesium (Cs), barium (Ba), Ga, and Ge.

### 2. Silicon Clathrate Producing Step

The silicon clathrate producing step in the present disclosure is a step of producing the silicon clathrate-type crystal phase by heating the Na—Si alloy to reduce the amount of Na in the Na—Si alloy. The silicon clathrate-type crystal phase may be a crystal phase of Type I silicon clathrate or a crystal phase of Type II silicon clathrate. The crystal phase of Type I silicon clathrate or the crystal phase of Type II silicon clathrate can be obtained by changing heating conditions as appropriate. In the silicon clathrate producing step, a scavenger is used to scavenge Na in the Na—Si alloy.

Examples of the scavenger include a Na getter agent that reacts with Na vapor generated from the Na—Si alloy. The Na getter agent is placed, for example, out of contact with the Na—Si alloy. Examples of the Na getter agent include SiO, MoO₃, and FeO. When the Na getter agent is used, the silicon clathrate producing step is preferably performed in a reduced pressure atmosphere.

Other examples of the scavenger include a Na trapping agent that receives Na by reacting directly with the Na—Si alloy. The Na trapping agent is placed, for example, in contact with the Na—Si alloy. Examples of the Na trapping agent include CaCl₂, AlF₃, CaBr₂, CaI₂, Fe₃O₄, FeO, MgCl₂, ZnO, ZnCl₂, and MnCl₂. When the Na trapping agent is used, the silicon clathrate producing step may be performed in a reduced pressure atmosphere or in a normal pressure atmosphere.

The heating temperature in the silicon clathrate producing step is, for example, 100° C. or more, and may be 200° C. or more, or 270° C. or more. The heating temperature is, for example, 500° C. or less, and may be 400° C. or less.

### 3. Active Material

The active material obtained by the steps described above has the silicon clathrate-type crystal phase. The active material has the voids inside the primary particles. Regarding the preferable range of the void volume of the active material, the preferable ranges of I_{A}/I_{M} and I_{B}/I_{M}, and other matters, the details described above in “A. Active Material” can be referred to as appropriate.

### E. Method for Producing Negative Electrode Layer

The present disclosure provides a method for producing a negative electrode layer, including an active material producing step for producing an active material by the above method for producing the active material, and a negative electrode layer forming step for forming a negative electrode layer by using the active material.

According to the present disclosure, the negative electrode layer having a small volume change due to charging and discharging can be obtained by using the active material described above. The active material producing step is the same as that described above in “D. Method for Producing Active Material”. The method for forming the negative electrode layer is not particularly limited, and various methods can be adopted. Examples of the method for forming the negative electrode layer include a method of applying a slurry containing at least the active material to the negative electrode current collector and drying the slurry.

When forming the negative electrode layer, pressing may be performed to press the negative electrode layer in the thickness direction. Examples of the pressing include roller pressing and flat plate pressing. Regarding the preferable form of the negative electrode layer to be obtained, the details described above in “B. Negative Electrode Layer” can be referred to as appropriate.

### F. Method for Producing Battery

The present disclosure provides a method for producing a battery, including an active material producing step for producing an active material by the above method for producing the active material, and a negative electrode layer forming step for forming a negative electrode layer by using the active material.

According to the present disclosure, the battery having a small volume change due to charging and discharging can be obtained by using the active material described above. The active material producing step and the negative electrode layer forming step are the same as those described above in “D. Method for Producing Active Material” and “E. Method for Producing Negative Electrode Layer”. The method for forming the battery is not particularly limited, and various methods can be adopted. In addition to the active material producing step and the negative electrode layer forming step, the method for producing the battery in the present disclosure may include a positive electrode layer forming step for forming a positive electrode layer, an electrolyte layer forming step for forming an electrolyte layer, and a disposing step for disposing the positive electrode layer, the electrolyte layer, and the negative electrode layer in this order. Regarding the preferable form of the battery to be obtained, the details described above in “C. Battery” can be referred to as appropriate.

The present disclosure is not limited to the above embodiment. The above embodiment is illustrative, and anything having substantially the same configuration as, and having similar functions and effects to, the technical idea described in the claims of the present disclosure is included in the technical scope of the present disclosure.

### Example 1

Si powder (Si powder having no voids inside primary particles; SIE23PB produced by Kojundo Chemical Laboratory Co., Ltd.) was prepared as a Si source. A Na—Si alloy was produced by using the Si source and using NaH as a Na source. As NaH, NaH prewashed with hexane was used. The Na source and the Si source were weighed to a molar ratio of 1.05:1 and mixed by using a cutter mill. This mixture was heated in an Ar atmosphere at 400° C. for 40 hours in a heating furnace to obtain a powdery Na—Si alloy.

The silicon clathrate producing step by a solid phase method was performed by using the obtained Na—Si alloy and further using AlF₃ as a Na trapping agent. The Na—Si alloy and AlF₃ were weighed to a molar ratio of 1:0.35 and mixed by using a cutter mill to obtain a reaction raw material. The obtained powdery reaction raw material was placed in a stainless steel reaction vessel and heated in an Ar atmosphere at 310° C. for 60 hours in a heating furnace to cause a reaction. The obtained reaction product may contain the desired active material and NaF and Al as by-products. This reaction product was washed with a mixed solvent of HNO₃ and H₂O at a volume ratio of 90:10. Thus, the by-products in the reaction product were removed. The washed reaction product was filtered, and the obtained solid content was dried at 120° C. for 3 hours or more to obtain a powdery active material.

### Example 2

Mg powder and Si powder were weighed to a molar ratio of 2.02:1, mixed in a mortar, and heated in an Ar atmosphere at 580° C. for 12 hours in a heating furnace to cause the MG powder and the Si powder to react with each other. The resultant mixture was cooled to room temperature to obtain Mg₂Si in the form of an ingot. Mg₂Si was pulverized at 300 rpm for 3 hours by a ball mill using zirconia balls of 3 mm in diameter. Then, the pulverized Mg₂Si was heated under a flow of a mixed gas of Ar and O₂ at a volume ratio of 95:5 at 580° C. for 12 hours in a heating furnace to cause oxygen in the mixed gas and Mg₂Si to react with each other. The obtained reaction product may contain Si and MgO. This reaction product was washed with a mixed solvent of H₂O, HCl, and HF at a volume ratio of 47.5:47.5:5. Thus, an oxide film on the Si surface and MgO in the reaction product were removed. The washed reaction product was filtered, and the obtained solid content was dried at 120° C. for 3 hours or more to obtain powdery porous Si. An active material was obtained in the same manner as in Example 1 except that the obtained porous Si was used as the Si source instead of the Si powder.

### Example 3

Metallic Li and Si powder were weighed to a molar ratio of 4:1 and mixed in an Ar atmosphere at room temperature for 0.5 hours in a mortar to cause the metallic Li and the Si powder to react with each other. Thus, Li₄Si was obtained. The obtained Li₄Si was caused to react with ethanol in an Ar atmosphere. The obtained reaction product may contain Si and CH₃CH₂OLi. This reaction product was filtered, and the obtained solid content was dried at 120° C. for 3 hours or more to obtain powdery porous Si. An active material was obtained in the same manner as in Example 1 except that the obtained porous Si was used as the Si source instead of the Si powder.

### Example 4

Powdery porous Si was obtained in the same manner as in Example 3. An active material was obtained in the same manner as in Example 1 except that the obtained porous Si was used as the Si source instead of the Si powder and the heating conditions after the addition of AlF₃ were changed from 310° C. and 60 hours to 310° C. and 120 hours.

### Example 5

Powdery porous Si was obtained in the same manner as in Example 3. An active material was obtained in the same manner as in Example 1 except that the obtained porous Si was used as the Si source instead of the Si powder and the heating conditions after the addition of AlF₃ were changed from 310° C. and 60 hours to 290° C. and 120 hours.

### Example 6

Powdery porous Si was obtained in the same manner as in Example 3. An active material was obtained in the same manner as in Example 1 by using the obtained porous Si as the Si source instead of the Si powder. Then, the obtained active material was washed by being immersed in an aqueous HF solution for 3 hours (HF washing).

### Example 7

Powdery porous Si (first porous Si) was obtained in the same manner as in Example 2. Powdery porous Si (second porous Si) was obtained in the same manner as in Example 3 except that the obtained first porous Si was used instead of the Si powder. An active material was obtained in the same manner as in Example 1 except that the obtained second porous Si was used as the Si source instead of the Si powder.

### Example 8

Second porous Si was obtained in the same manner as in Example 7. An active material was obtained in the same manner as in Example 1 except that the obtained second porous Si was used as the Si source instead of the Si powder and the heating conditions after the addition of AlF₃ were changed from 310° C. and 60 hours to 270° C. and 120 hours.

### Example 9

An active material was obtained in the same manner as in Example 7. Then, the obtained active material was washed by being immersed in an aqueous HF solution for 3 hours (HF washing).

### Example 10

Porous Si was obtained in the same manner as in Example 3 except that the amounts of use of metallic Li and Si powder were adjusted. The obtained porous Si was used as an active material.

### Comparative Example 1

Si particles were used as the Si source, and Na particles were used as the Na source. The Si particles and the Na particles were mixed to a molar ratio of 1:1, placed in a crucible, sealed in an Ar atmosphere, and heated at 700° C. to obtain a Na—Si alloy. The obtained Na—Si alloy was heated under vacuum (about 1 Pa) at 340° C. to remove Na, thereby obtaining an intermediate having a crystal phase of Type II silicon clathrate. The obtained intermediate and Li metal were weighed at a molar ratio of Li/Si=2.5 and mixed in an Ar atmosphere in a mortar to obtain an alloy compound. The obtained alloy compound was caused to react with ethanol in an Ar atmosphere to form voids inside primary particles, thereby obtaining an active material.

### Evaluation

### XRD Measurement

The active materials obtained in Examples 1 to 9 and Comparative Example 1 were subjected to X-ray diffraction (XRD) measurement using CuKα rays. As a result, it was confirmed that all the active materials had the crystal phase of Type II silicon clathrate as their main phase.

The intensity of the peak A near 2θ=20.09° in the crystal phase of Type II silicon clathrate was represented by I_{A}, and the intensity of the peak B near 2θ=31.72° was represented by I_{B}. The maximum intensity at 2θ=22° to 23° was represented by I_{M}, and I_{A}/I_{M} and I_{B}/I_{M} were determined. The results are shown in Table 1.

### Measurement of Void Volumes

The void volumes of the active materials obtained in Examples 1 to 10 and Comparative Example 1 were determined. A mercury porosimeter was used to measure the void volumes. A PoreMaster 60-GT (QuantaChrome Co.) was used as the measurement apparatus, and the measurement was carried out in a range of 40 Å to 4,000,000 Å. The Washburn method was used for analysis. The results are shown in Table 1.

TABLE 1

| | | Void volume of negative electrode | | | | | | |
|---|---|---|---|---|---|---|---|---|
| | | active material (cc/g) | | | | | | |
| | | Void | Void | Void | | | | |
| | | volume X | volume Y | volume Z | | | | |
| | | (0 to 10 | (0 to 50 | (0 to 100 | | | | |
| | Crystal | nm) | nm) | nm) | X/Y | X/Z | I_{A}/I_{M} | I_{B}/I_{M} |
| Example 1 | Clathrate | 0.0167 | 0.072 | 0.100 | 0.232 | 0.167 | 3.330 | 3.800 |
| Example 2 | Clathrate | 0.0230 | 0.107 | 0.230 | 0.215 | 0.100 | 1.890 | 1.640 |
| Example 3 | Clathrate | 0.0337 | 0.157 | 0.210 | 0.215 | 0.161 | 1.820 | 1.490 |
| Example 4 | Clathrate | 0.0854 | 0.217 | 0.253 | 0.394 | 0.338 | 2.560 | 1.800 |
| Example 5 | Clathrate | 0.0438 | 0.107 | 0.135 | 0.409 | 0.324 | 2.110 | 1.420 |
| Example 6 | Clathrate | 0.0363 | 0.171 | 0.248 | 0.212 | 0.146 | 9.714 | 6.857 |
| Example 7 | Clathrate | 0.0339 | 0.101 | 0.130 | 0.336 | 0.261 | 4.800 | 3.400 |
| Example 8 | Clathrate | 0.0320 | 0.083 | 0.120 | 0.386 | 0.267 | 2.121 | 1.591 |
| Example 9 | Clathrate | 0.0195 | 0.112 | 0.390 | 0.174 | 0.050 | 4.727 | 3.455 |
| Example 10 | Diamond | 0.0245 | 0.142 | 0.245 | 0.173 | 0.100 | 1.120 | 0.780 |
| Comparative | Clathrate | 0.0035 | 0.033 | 0.120 | 0.107 | 0.029 | 1.030 | 1.040 |
| Example 1 | | | | | | | | |

As shown in Table 1, the void volume X and the void volume Y were larger in Examples 1 to 10 than in Comparative Example 1. It was confirmed that I_{A}/I_{M} and I_{B}/I_{M} were larger than 1 and the crystal phase of Type II silicon clathrate was formed in all of Examples 1 to 9 and Comparative Example 1.

In Comparative Example 1, Si was made clathrate (Na alloying and Na desorption) and then made porous. When the amount of Li for use in pore formation is increased in this case, the crystal phase of Type II silicon clathrate may disappear. Therefore, the amount of use of Li is limited. In Examples 2 to 9, Si was made porous and then made clathrate. In this case, the amount of Li for use in pore formation can be increased and sufficient pore formation can be achieved. When sufficiently porous Si is made clathrate at a high temperature, the minute voids may disappear. In Examples 2 to 9, Si can be made clathrate at a low temperature by using a scavenger. As a result, it is presumed that the void volume X and the void volume Y increased in the active materials obtained in Examples 2 to 9.

### Measurement of Confining Pressure Increase Amounts

All-solid-state batteries were produced by using the active materials obtained in Examples 1 to 10 and Comparative Example 1 as negative electrode active materials. The production method is as follows.

### (1) Production of Negative Electrode

The obtained active material, a sulfide solid electrolyte (Li₂S—P₂S₅ glass ceramic), a conductive material (VGCF), a butyl butyrate solution containing a PVDF binder at a ratio of 5 wt %, and butyl butyrate were added to a polypropylene container and stirred for 30 seconds with an ultrasonic dispersion apparatus (UH-50 manufactured by SMT Co., Ltd.). Next, the container was shaken for 30 minutes with a shaker (TTM-1 manufactured by Sibata Scientific Technology Ltd.). The obtained mixture was applied onto a negative electrode current collector (Cu foil produced by UACJ) by a blade method using an applicator and dried at 100° C. for 30 minutes on a hot plate. Thus, a negative electrode including the negative electrode current collector and a negative electrode layer was obtained.

### (2) Production of Positive Electrode

A positive electrode active material (LiNi_{1/3}Co_{1/3}Mn_{1/3}O₂; average particle size of 6 μm), a sulfide solid electrolyte (Li₂S—P₂S₅ glass ceramic), a conductive material (VGCF), a butyl butyrate solution containing a polyvinylidene fluoride (PVDF) binder at a ratio of 5 wt %, and butyl butyrate were added to a polypropylene container and stirred for 30 seconds with an ultrasonic dispersion apparatus (UH-50 manufactured by SMT Co., Ltd.). Next, the container was shaken for 3 minutes with a shaker (TTM-1 manufactured by Sibata Scientific Technology Ltd.). The obtained mixture was applied onto a positive electrode current collector (Al foil produced by Showa Denko K. K.) by a blade method using an applicator and dried at 100° C. for 30 minutes on a hot plate. Thus, a positive electrode including the positive electrode current collector and a positive electrode layer was obtained. The area of the positive electrode was smaller than that of the negative electrode.

### (3) Production of Solid Electrolyte Layer

A sulfide solid electrolyte (Li₂S—P₂S₅ glass ceramic), a heptane solution containing a butylene rubber-based binder at a ratio of 5 wt %, and heptane were added to a polypropylene container and stirred for 30 seconds with an ultrasonic dispersion apparatus (UH-50 manufactured by SMT Co., Ltd.). Next, the container was shaken for 30 minutes with a shaker (TTM-1 manufactured by Sibata Scientific Technology Ltd.). The obtained mixture was applied onto a release sheet (Al foil) by a blade method using an applicator and dried at 100° C. for 30 minutes on a hot plate. Thus, a transfer member including the release sheet and a solid electrolyte layer was obtained.

(4) Production of all-Solid-State Battery

A solid electrolyte layer for bonding was placed on the positive electrode layer of the positive electrode, set in a roll pressing machine, and pressed under 100 kN/cm at 165° C. Thus, a first laminate was obtained.

Next, the negative electrode was set in the roll pressing machine and pressed under 60 kN/cm at 25° C. Thus, the pressed negative electrode was obtained. Then, the solid electrolyte layer for bonding and the transfer member were placed in order from the negative electrode layer side. At this time, the solid electrolyte layer for bonding and the solid electrolyte layer in the transfer member were placed to face each other. The obtained laminate was set in a flat uniaxial pressing machine and temporarily pressed under 100 MPa at 25° C. for 10 seconds. Then, the release sheet was released from the solid electrolyte layer. Thus, a second laminate was obtained.

Next, the solid electrolyte layer for bonding in the first laminate and the solid electrolyte layer in the second laminate are placed to face each other, set in the flat uniaxial pressing machine, and pressed under 200 MPa at 120° C. for 1 minute. Thus, an all-solid-state battery was obtained.

### (5) Measurement of Confining Pressure Increase Amounts

The obtained all-solid-state battery was charged and a confining pressure increase amount was measured. The test conditions were a confining pressure (fixed) of 5 MPa, charging at 0.1 C, and a cut-off voltage of 4.55 V. The confining pressure at 4.55 V was measured, and a confining pressure increase amount from the state before the charging was determined. The results are shown in Table 2. The results of the confining pressure increase amount in Table 2 are relative values when the result in Comparative Example 1 is regarded as 100.

TABLE 2

| | | | | | Confining |
|---|---|---|---|---|---|
| | | Void volume of negative electrode active material (cc/g) | | | pressure |
| | | Void volume | Void volume | Void volume | increase |
| | | X | Y | Z | amount |
| | Crystal | (0 to 10 nm) | (0 to 50 nm) | (0 to 100 nm) | (relative value) |
| Example 1 | Clathrate | 0.0167 | 0.072 | 0.100 | 65 |
| Example 2 | Clathrate | 0.0230 | 0.107 | 0.230 | 54 |
| Example 3 | Clathrate | 0.0337 | 0.157 | 0.210 | 17 |
| Example 4 | Clathrate | 0.0854 | 0.217 | 0.253 | 33 |
| Example 5 | Clathrate | 0.0438 | 0.107 | 0.135 | 26 |
| Example 6 | Clathrate | 0.0363 | 0.171 | 0.248 | 15 |
| Example 7 | Clathrate | 0.0339 | 0.101 | 0.130 | 24 |
| Example 8 | Clathrate | 0.0320 | 0.083 | 0.120 | 22 |
| Example 9 | Clathrate | 0.0195 | 0.112 | 0.390 | 52 |
| Example 10 | Diamond | 0.0245 | 0.142 | 0.245 | 54 |
| Comparative | Clathrate | 0.0035 | 0.033 | 0.120 | 100 |
| Example 1 | | | | | |

As shown in Table 2, it was confirmed that the confining pressure increase amount was smaller in Examples 1 to 10 than in Comparative Example 1. This is presumably because the negative electrode active materials obtained in Examples 1 to 10 have many minute voids having the pore diameter of 10 nm or less.

### Measurement of Void Volumes

Pressed negative electrodes were obtained in the same manner as described above in “Measurement of Confining Pressure Increase Amounts” by using the active materials obtained in Examples 1 to 3, 6, and 10 and Comparative Example 1. The void volumes of the negative electrode active materials in the pressed negative electrodes were determined. The method for measuring the void volume is the same as that described above. The results are shown in Table 3.

TABLE 3

| | | Void volume of negative | | | | |
|---|---|---|---|---|---|---|
| | | electrode active material | | | | |
| | | after pressing (cc/g) | | | | |
| | | Void | Void | Void | | |
| | | volume | volume | volume | | |
| | | P (0 to | Q (0 to | Z (0 to | | |
| | Crystal Si | 10 nm) | 50 nm) | 100 nm) | P/Q | P/R |
| Example 1 | Clathrate | 0.0150 | 0.0411 | 0.0532 | 0.365 | 0.282 |
| Example 2 | Clathrate | 0.0170 | 0.0440 | 0.1200 | 0.386 | 0.142 |
| Example 3 | Clathrate | 0.0220 | 0.0970 | 0.1100 | 0.227 | 0.200 |
| Example 6 | Clathrate | 0.0307 | 0.1100 | 0.1557 | 0.279 | 0.197 |
| Example 10 | Diamond | 0.0173 | 0.0554 | 0.0580 | 0.312 | 0.298 |
| Comparative | Clathrate | 0.0039 | 0.0115 | 0.0137 | 0.342 | 0.286 |
| Example 1 | | | | | | |

As shown in Table 3, it was confirmed that the void volumes of the negative electrode active materials after pressing were larger in Examples 1 to 3, 6, and 10 than in Comparative Example 1.

What is claimed is:

1. An active material comprising silicon, wherein
the active material has voids inside primary particles, and
a void volume X of voids having a pore diameter of 10 nm or less among the voids is 0.015 cc/g or more.

2. The active material according to claim 1, wherein the void volume X is 0.09 cc/g or less.

3. The active material according to claim 1, wherein a void volume Y of voids having a pore diameter of 50 nm or less among the voids is 0.05 cc/g or more and 0.25 cc/g or less.

4. The active material according to claim 3, wherein a ratio (X/Y) of the void volume X to the void volume Y is 0.17 or more and 0.41 or less.

5. The active material according to claim 1, wherein a void volume Z of voids having a pore diameter of 100 nm or less among the voids is 0.05 cc/g or more and 0.40 cc/g or less.

6. The active material according to claim 5, wherein a ratio (X/Z) of the void volume X to the void volume Z is 0.10 or more and 0.34 or less.

7. The active material according to claim 1, wherein the active material has a crystal phase of Type II silicon clathrate.

8. The active material according to claim 7, wherein:
a peak A at 2θ=20.09°±0.50° and a peak B at 2θ=31.72°±0.50° are observed as peaks of the crystal phase of the Type II silicon clathrate in X-ray diffraction measurement using CuKα rays; and
when an intensity of the peak A is I_{A}, an intensity of the peak B is I_{B}, and a maximum intensity at 2θ=22° to 23° is I_{M}, I_{A}/I_{M} is 1.75 or more and 10 or less, and I_{B}/I_{M} is 1.35 or more and 7 or less.

9. The active material according to claim 1, wherein the active material has a crystal phase of diamond-type silicon.

10. A negative electrode layer comprising an active material including silicon, wherein
the active material has voids inside primary particles, and
a void volume P of voids having a pore diameter of 10 nm or less among the voids is 0.015 cc/g or more.

11. The negative electrode layer according to claim 10, wherein the void volume P is 0.031 cc/g or less.

12. The negative electrode layer according to claim 10, wherein a void volume Q of voids having a pore diameter of 50 nm or less among the voids is 0.035 cc/g or more and 0.11 cc/g or less.

13. The negative electrode layer according to claim 12, wherein a ratio (P/Q) of the void volume P to the void volume Q is 0.22 or more and 0.39 or less.

14. The negative electrode layer according to claim 10, wherein a void volume R of voids having a pore diameter of 100 nm or less among the voids is 0.053 cc/g or more and 0.16 cc/g or less.

15. The negative electrode layer according to claim 14, wherein a ratio (P/R) of the void volume P to the void volume R is 0.14 or more and 0.30 or less.

16. A battery comprising:
the negative electrode layer according to claim 10;
a positive electrode layer; and
an electrolyte layer disposed between the positive electrode layer and the negative electrode layer.

17. A method for producing the active material according to claim 1, the method comprising:
obtaining a Na—Si alloy by causing a sodium source and a silicon source to react with each other; and
producing a silicon clathrate-type crystal phase by heating the Na—Si alloy to reduce an amount of sodium in the Na—Si alloy, wherein
the producing the silicon clathrate-type crystal phase uses a scavenger to scavenge the sodium in the Na—Si alloy.

18. A method for producing a negative electrode layer, the method comprising:
producing an active material by the method for producing the active material according to claim 17; and
forming the negative electrode layer by using the active material.

19. A method for producing a battery, the method comprising:
producing an active material by the method for producing the active material according to claim 17; and
forming a negative electrode layer by using the active material.
